(19) United States
(12) Patent Application Publication
(10) Pub. No.: US 2003/0147383 A1
(43) Pub. Date: Aug. 7, 2003

(54) Object communication services software development system and methods

(76) Inventors: Karen Capers, Castle Rock, CO (US); Peter Alvin, Colorado Springs, CO (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/965,358

(22) Filed: Sep. 26, 2001

(51) Int. Cl. H04L 12/66; H04Q 7/24

(52) U.S. Cl. 370/356; 370/338

(57) ABSTRACT

A novel method and system are herein described for enabling communications between distributed network objects. In general, a system and method for providing communications between network objects, the means and steps of said system and method comprising: registering said objects desiring communications; accepting a communications message from at least one of said objects, said communication addressing one of said plurality of network objects; determining the mode of message delivery for said message; delivering said message according to the mode of message delivery determined.

### STATEMENT OF RELATED CASES

The following related cases are co-pending, co-owned patent applications—herein incorporated by reference—filed on even date as the present application:

Ser. No. ______ entitled “INTEGRATED DIAGNOSTIC CENTER” to Karen Capers and Michael Brooking.

Ser. No. ______ entitled “PRESENTATION SERVICES SOFTWARE DEVELOPMENT SYSTEM AND METHODS” to Karen Capers and Laura Wiggett.

### BACKGROUND OF THE INVENTION

The convergence between legacy PBX, corporate IP Networks, on the one hand, and wireless communications, on the other, is continuing apace. Corporate GSM (or more generally, Office Land Mobile Network, or OLMN) systems that allow a subscribed user to roam onto a corporate wireless subsystem “campus” from the public land mobile network (PLMN) are known in the art.

With newer generations of such OLMNs rolling out, new services are being expected and demanded by the users of such systems. It is typically desirable to have such services—from new communications services to enhancing existing legacy services—seamlessly presented to the user (across the various platforms—PBX, network and wireless—within a given campus). Additionally, it is desirable to have these new services interoperating across various legacy PBX, networks and wireless subsystems—perhaps involving multiple manufacturers, protocols, operating systems and like.

It is additionally desirable to for these services to run robustly. Thus, messages can be delivered to end users even though there may be point failures in the OLMN. Additionally, it may be the case that, for communication systems developers, the location of the components that need to communicate on the network is not static, but changes often. Thus, it is desirable to have a development system that anticipates situations that require a wide variety of communication delivery modes and service. It is also desirable to have a development system that anticipates a wide variety of message formats that may differ in both their semantics and syntax.

### SUMMARY OF THE INVENTION

The present invention discloses a novel system and method for providing communications between network objects (or clients) within an OLMN. The presently claimed system supports a variety of communication services to clients for delivering opaque messages on a communications network. Opaque message delivery allows users/clients to send any message format they wish. The present system allows any client—regardless of operating system and programming language—to use the Object Communication Service (OCS). Store-and-forward feature allows the client to send the message regardless of the state of the destination (e.g. whether it is down at the time). The present system also allows for multiple delivery modes; thus, there is no single point of failure.

In general, a client registers with the OCS using the present system. Once registered, the client is able to invoke the communication services offered by the system. The client is offered two modes of operation: (1) store-and-forward/broadcast communication between the client and multiple destination; and (2) peer-to-peer communication between the client and the destination.

In another aspect of the present invention, a novel method and system are herein described for enabling communications between distributed network objects. In general, a system and method for providing communications between network objects, the means and steps of said system and method comprising: registering said objects desiring communications; accepting a communications message from at least one of said objects, said communication addressing one of said plurality of network objects; determining the mode of message delivery for said message; delivering said message according to the mode of message delivery determined.

### BRIEF DESCRIPTION OF THE DRAWINGS

FIG. 1 is a typical embodiment of an OLMN architecture.

FIG. 2 is a Use-Case diagram description of the name service employed by the present invention.

FIG. 3 is a Use-Case diagram description of the event component employed by the present invention.

### DETAILED DESCRIPTION OF THE INVENTION

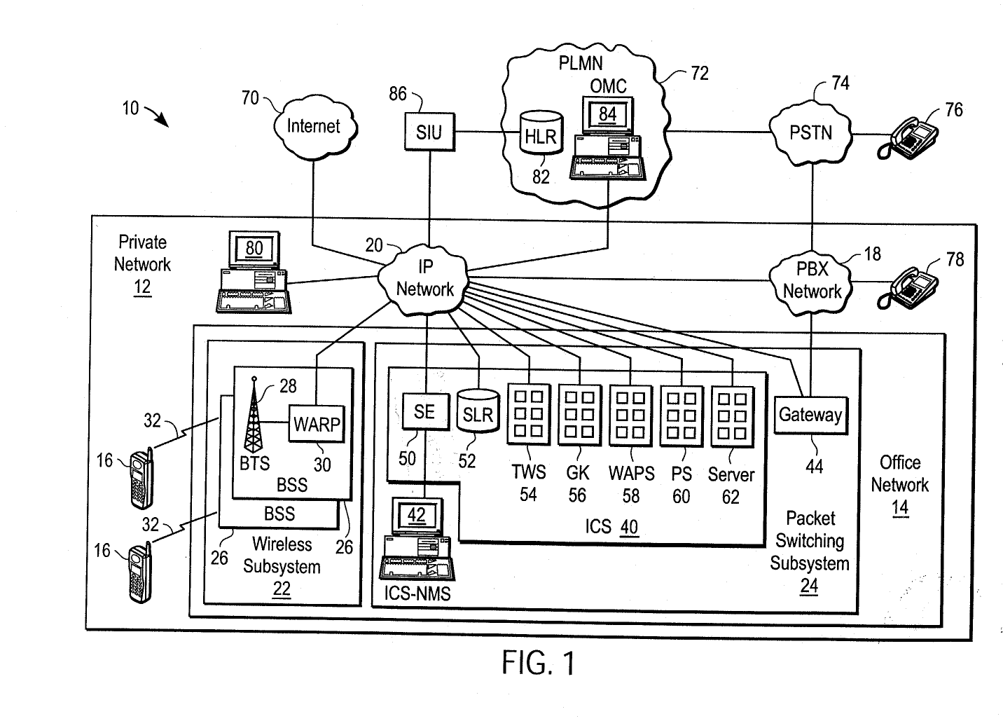

FIG. 1 depicts a typical architecture of an Office Land Mobile Network (e.g. Corporate GSM or “C-GSM”)—illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAMP) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) (alternatively called “IWG”) 30. Each base station 28 is operable to provide communication between the corresponding WARP 30 and mobile devices 16 located in a specified geographical area.

Authorized mobile devices 16 are operable to provide wireless communication within the private network 12 for authorized subscribers. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAMP functions for each of the network elements through the ICS 40. Thus, for example, an operator may perform OAMP functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAMP interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits (ASICs), field-programmable gate arrays (FPGAs), digital signal processors (DSPs), other suitable specific or general purpose processors, transmission media or other suitable media in which logic may be encoded and utilized. As described in more detail below, the ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

Overview and Architecture

OCS (Object Communications Services) provides message-oriented point-to-point and publish-subscribe (“pub/sub”) functionality to network “objects”—ICS components, users, frameworks and perhaps to other subsystems. Thus, the term “object” is broadly interpreted to be any entity engaged in communication in the present system. Because ICS components must be location independent, all ICS components must use OCS to communicate with one another (except possibly for calling library components).

In addition to message communications, OCS also provides component “in service” and “out of service” notifications that are sent to other interested components. Any component can also query at any point in time if another component is currently in service or not.

In one embodiment, a messaging-oriented mechanism could be implemented as opposed to a remote procedure call (RPC) mechanism because loose-coupling is more desirable than tight-coupling. Messages are also highly desirable for communicating between different programming languages. However, it will be appreciated that tight-coupling messaging such as RPC could be implemented as well.

Further in the embodiment, the OCS clients communicate between each other through an OCS server. Therefore, messages that are sent between clients travel through the server. It will be appreciated, however, that another embodiment of the present invention could support and allow peer-to-peer communication to bypass the server. For example, in one peer-to-peer mode embodiment, an OCS client communicates with a peer by ending a message to the peer's Ipoint interface. In this mode, the OCS server is not involved.

In one embodiment, the OCS server can be implemented as a standalone Java application that can be started from the command line. A Startup Server also starts the OCS Server. As a design choice, TCP/IP sockets could be used for communication. Thus, if the server should be manually stopped, the client socket code will automatically reconnect to the server when it is back online.

A single instance of the OCS server should be running on some machine that is reachable over the network from the clients. An OCS jar file could be downloaded from an ICS Javadocs page and copied over to a Windows or Linux box.

For example, to start the server:

% java -cp OCS.jar

com.opuswave.ics.serviceEngine.ocs.server.OCSServer

Server logging is made to the following file: /tmp/ocslog.txt

On Linux, view the log in real-time by running “tail-f/tmp/ocslog.txt”.

Log entries may look something like this: (Names that begin with an asterisk (*) are built-in system values.)

[3:51:20 PM] OCSServer started on port 54321
[3:51:26 PM] Connect C2
[3:51:30 PM] Connect C1
[3:51:30 PM] Send C1 −> C2
[3:51:30 PM] 6 items:

*sender=C1 (java.lang.String)
name=Peter (java.lang.String)
three bytes (Java.lang.Byte)

00000 020100

days in year=365 (java.lang.Long)
*seq=1 (java.lang.Long)
*synchronous=true (java.lang.Boolean)

[3:51:31 PM] Response C2 −> C1
[3:51:31 PM] 6 items:

*sender=C2 (java.lang.String)
*receiver=C1 (java.lang.String)
days in year=333 (java.lang.Long)
cartoon (java.lang.Object)

| | | | | | |
|---|---|---|---|---|---|
| 00000 | ACED0005 | 73720032 | 636F6D2E | 6F707573 | ....sr.2 com.opus |
| 00016 | 77617665 | 2E696373 | 2E736572 | 76696365 | wave.ics .service |
| 00032 | 456E6769 | 6E652E6F | 63732E6D | 65737361 | Engine.o cs.messa |
| 00048 | 67696E67 | 2E417070 | 6C65C115 | 98DFE4A6 | ging.App le...... |
| 00064 | 6A260200 | 014C0004 | 736F6E67 | 7400124C | j&...L.. songt. .L |
| 00080 | 6A617661 | 2F6C616E | 672F5374 | 72696E67 | java/lan g/String |
| 00096 | 3B787074 | 000B4261 | 72727920 | 57686974 | ;xpt..Ba rry Whit |
| 00112 | 65 | | | | e |

*synchronous=false (java.lang.Boolean)
*seq=1 (java.lang.Long)

[3:51:46 PM] Disconnect C1
[3:51:56 PM] Disconnect C2

Client Configuration

In one possible embodiment, Java and C++ client configuration information is read from the following file: /tmp/ocsproperties.txt

This client configuration may contain the following values [default value]:

| | |
|---|---|
| server={IP-Address} | # set to “localhost” (without quotes) or |

IP address [localhost]

| | |
|---|---|
| trace={0\|1} | # set to 1 to turn on System.out.println trace |

[0]

| | |
|---|---|
| log={0\|1} | # set to 1 to log messages to /tmp log files |

[1]

| | |
|---|---|
| logSystemPairs={0\|1} | # set to 1 to log system name/value pairs |

[0]

(those pair names that begin with asterisk

(*)

in message logs: *from, *to, etc.)

| | |
|---|---|
| port={number} | # FUTURE: port number [54321] |

| | |
|---|---|
| logObjects={0\|1} | # FUTURE: because object hex dumps can get |

long, this can

be set to omit that long output [0]

| | |
|---|---|
| synchTimeoutMS={number} | # FUTURE: interval to wait during a |

synchronous call waiting

for a reply. [20000]

Clients may also write diagnostic log output to the /tmp directory. The filename format is: //tmp/ocslog_<clientName>.txt. Therefore, if two clients are running the same machine, both have distinct log files.

Programming

Before sending or receiving messages, it is desired to register with the OCSServer. It is possible to call the static method MessagingFactory.createInstance to obtain an OCS interface:

Ipoint

Ipublish

Isubscribe

Then it is possible to register your identity:

TheInterfaceReference.register(“your well-known name here”,

MessagingConstants.ICS_PASSWORD);

A password is now required to authenticate ICS clients. All ICS will use the ICS_PASSWORD password.

As a shortcut, if desired

i. only receive, or

ii. send and receive

It is possible to call the listen method:

point.listen(“your well-known name here”,

objectReferenceThatImplementsListenInterface);

It is possible to register more than once (subsequent registers are NO-OPS). However, it is not desired to re-register with a new identity name.

All point names registering with a particular OCS server should be unique. Otherwise, an exception will be thrown if a registration is attempted when another client has already registered under that name.

For pub/sub, the name of the point should still be registered so that the publisher and subscriber names can correctly appear in the logs.

At present it is not possible to do Point-to-Point and Pub/Sub using the same interface. In this embodiment, MessagingFactory.createInstance should be called twice to obtain both interfaces.

Filtering Messages

The ability for a point to only accept incoming messages from an approved set of source points. A new third parameter has been added to the listen( ) method:

public void listen(String point, IListen receive, String friendList)

throws Exception;

The friendList is a comma-delimited list of source points to accept messages from. Messages from all other points are filtered. Example:

point.listen(“SLR”, new MyListener( ), “SubAgent,PizzaMan”); //

Only accept messages from the SubAgent and PizzaMan points

Disconnecting from the Server

To disconnect from the server, it is possible to call the unregister method:

TheInterfaceReference.unregister( );

This kills the internal thread so that the application can exit.

Messages are implemented as a collection of name/value pairs stored in the OCSMap class.

The collection is a “map” data structure. Each name is a handle to a particular value. Names are not case sensitive. Subsequent setting of values overwrites previous values. Names can contain space characters.

It is possible to use the isSet( ) method to see if a name was sent.

All map assessor methods can throw the NotFoundException exception:

try {

Boolean bSomeFlag = map.getBoolean(“someFlaq”);

} catch (NotFoundException e) {

System.out.println(“couldn't obtain value: ” + e);

}

There are two possible exception message strings:

getBoolean: couldn't find %NAME%

getBoolean: %NAME%: value exists but isn't a Boolean value

The OCS datatypes currently supported are:

String

Long

Int

Boolean

Byte[ ]

Object

Any number of pairs can be sent in a single OCSMap.

Currently, the total aggregate byte size of a OCSMap object cannot exceed 10,000 bytes.

Java Objects intended to be stored in an OCSMap must implement the Serializable interface.

When replying to a synchronous message, it is desired to use the incoming OCSMap structure to send back the response values—as noted below in the “Receiving Messages” discussion for an example.

Sending Incoming Values Back To The Source

The incoming name/value pairs sent to a destination point will not be sent back to the source point. However, if it is desired an incoming value to be sent back in the reply, it is possible to use the keep method.

map.keep(“some name”);

This is equivalent to the following:

map.setDATATYPE(“some name”, map.getDATATYPE(“some name”));

Here is a complete example:

public class MyListener implements Ilisten {

public void onMap(boolean isSynchronous, IReply reply, OCSMap

map) {

if (isSynchronous) {

try {
// INCOMING VALUES
System.out.println(“received ” +

map.getString(“ColorsOfRainbow”) );

System.out.println(“received ” +

map.getLong(“SLRTimeoutValue”) );

// OUTGOING VALUES

map.setLong(“this is a new value sent back to

source point”, new Long(654321));

// The following two values were sent here from the

source point.

// Send them back with the new value above.

map.keep(“ColorsOfRainbow”); // send this

original value back to sender

map.keep(“SLRTimeoutValue”); // send this original

value back to sender

reply.sendMap(map);

} catch (Exception e) {

FATAL(“MyListener: problems setting values: ” + e);

}

}

}

}

Using a HashMap Instead of an OCSMap

It is possible to call the following two methods to export/import name/value pairs to/from a standard Java HashMap object:

public HashMap getMap( );

public void setMap(HashMap map) throws Exception;

Exporting values to a HashMap object allows passing the OCS values to parts of the system that do not have a dependency on OCS.

Here is an example where values are exported to a HashMap, then more values are added, then the values are imported back into the OCSMap object:

try {

OCSMap map = new OCSMap( );
Map.setString(“mystring”, “Willie Wonka”);
map.setLong(“mylong”, new Long(34));
TR(“toString=” + map.toString( ));
TR(“export and iterate initial values using the HashMap”);
HashMap hm = map.getMap( );
Set set = hm.keySet( );
For (Iterator i = set.iterator( ); i.hasNext( ) ; ) {

String sKey = (String)i.next( );
TR(“key=” + sKey );

}
TR(“add new values”);
Hm.put (“NEW STRING”, “Mellick”);
hm.put(“NEW LONG”, new Long(66));
hm.put(“NEW OBJECT”, new Person( ) );
hm.put(“NEW BOOLEAN”, new Boolean( true ));
Byte[] two = { new Byte((byte)10), new Byte((byte)20) };
Map.setBytes(“NEW BYTES”, two);
TR(“Call setMap to import values back into the OCSMap”);
Map.setMap( hm );
TR(“dump all values: ” + map.toString( ));

} catch (Exception e) {

FATAL(“” + e);

}

Sending Messages

Point-To-Point

Call the sendMap method to send a message to another point:

Public int sendMap(boolean bSynchronous, String destination,

OCSMap value) throws Exception;

It may be desired to create one sending interface reference per component and share the reference between all the classes of the component.

Synchronous: Point-to-point messages can be sent synchronous by passing ‘true’. This is the most common and convenient approach as the call will block until there is an outcome. Specifically, the following cases return on the following values:

int result = point.sendMap(true, “P2”, map); // blocks
switch (result) {

case MessagingConstants.MESSAGE_MAP: // success!

// obtain P2's returned values from same “map” object
System.out.println( map.getString(“United States Capitals”)

);

break;

case MessagingConstants.MESSAGE_TIMEOUT: // default is 10

second window to receive response

System.out.println( “OCS: didn't get reply from P2” );
break;

case MessagingConstants.MESSAGE_ERROR:

System.out.println( “OCS: Got error ” +

map.getString(“*errorMessage”) );

}

Asynchronous: Pass ‘false’ to send messages asynchronously. This is the “fire and forget” approach. The only two outcomes are success or error:

int result = point.sendMap(false, “P2”, map); // doesn't block
switch (result) {

case MessagingConstants.MESSAGE_SUCCESS:

// map object still only contains values that were sent to

P2 (no result values)

System.out.println( “A-OKAY” );
break;

case MessagingConstants.MESSAGE_ERROR:

System.out.println( “OCS: Got error ” +

map.getString(“*errorMessage”) );

break;

}

To receive responses for asynchronous messages, a listener routine should be invoked.

Pub/Sub

Call the sendMap( ) method of the IPublish interface:

pub.sendMap(“TopicA”, map);

All subscribers will receive the message in an undefined order. If there are no subscribers the message is thrown away.

Pub/sub messages are only asynchronous.

Receiving Messages

Incoming messages are handled in an event-driven programming mode, i.e., incoming messages are passed to a consumer's code via various call back-type mechanisms.

Messages are passed on OCS threads. Consumers, therefore, do not have to explicitly create threads to use OCS.

In the current embodiment, OCS does not support an event-getting mode where the consumer's code would block on a method call like “waitForIncomingMessage”.

In one embodiment, callbacks are implemented as follows:

C++: Write a class that inherits from OCSPoint.cc. Override the
virtual “onMap” method.

OnMap is called automatically when a message arrives.

Java: Write a class that implments the IListen interface. Another
class needs to instantiate

this receiver class and call the “listen” method to bind the

receiver with a well-known name

that senders use.

Point-to-Point

With this mode of communication, it is possible to elect to have as many receiving points in a component as desired. Preferably, a new IPoint should be created for every receiving point because typically it is not possible to associate different IListen objects using a single IPoint interface.

In Java, the IListen interface is used to receive messages:

void onMap(boolean isSynchronous, Ireply reply, OCSMap value);

The onMap( ) method is called for all incoming Point-to-Point and Pub/Sub messages. For Sub/Sub the isSynchronous parameter is always false.

If it is desired to reply to a synchronous message, use the same OCSMap object to send values back to the sender:

public void onMap(boolean isSynchronous, IReply reply, OCSMap map) {

try {

map.setString(“reply name”, “reply value”);
reply.sendMap (map);

} catch (Exception e) { }

}

However, it is not advisable to do this:

public void onMap(boolean isSynchronous, IReply reply, OCSMap map)

{

try {

OCSMap replyMap = new OCSMap ( ); // DON'T CREATE

NEW OCSMAP

replyMap.setString(“reply name”, “reply value”);
reply.sendMap(replyMap); // This

will thrown an exception

} catch (Exception e) { }

}

Receiving Pub/Sub Messages

Unlike IPoint, when subscribing it is allowed to call listen( ) multiple times to associate different message handlers with different topics. It is possible to receive multiple subscriptions using the same ISubscribe interface reference:

sub.listen(“topicA”, listenerA );

sub.listen(“topicB”, listenerB );
sub.listen(“topicC”, listenerC );

For Pub/Sub the IReply interface can be used to send an asynchronous Point-to-Point message back to the point that published the original message. Since the reply is Point-to-Point the replied message will not be received via the ISubscribe object (if there is one) of the publisher. This is a case of a message being delivered originally as Pub/Sub and replied to as Point-to-Point.

Multithreading

Sending

For sending, it is possible to re-use a single OCSMap object when sending to several points or the same point multiple times ASYNCHRONOUSLY. It is also desirable to use distinct OCSMap objects if sending SYNCHRONOUSLY.

Receiving

Received messages can now be processed in parallel without any additional coding. Just set the new “setMaxReceiveThreads” method to set the size of the thread pool. IListen's onMap( ) is called concurrently. OCS supports automatic parallel processing of received messages by calling the following method:

point.setMaxReceiveThreads(nbrOfThreads);

A thread pool is automatically used to manage multiple receiving threads.

Public class MyListener implements IListen {

public /*synchronous NO!!!*/ void onMap(boolean isSynchronous,

IReply reply, OCSMap map) {

// WILL BE CALLED BY MULTIPLE THREADS SIMULTANEOUSLY

// Do NOT make onMap synchronous!!! This will default the

multiprocessinq capabilities.

}

}

Point-In-Service Notifications

Automatic Point Notifications Invoke the notifyMe( ) method if it is desired to be notified when other points come in and out of service:

public void notifyMe(boolean bNotify, String point);

For example, some point wishes to watch the point named “SLR”:

point.notifyMe(true, “SLR”);

If it is desired to be notified if the OCSServer itself goes in or out of service, it is possible to pass the point name “OCSServer”.

When the SLR changes state onMap( ) will be called with the following OCSMap system name/value pairs:

| | |
|---|---|
| *type | - “notification” |
| *event | - “notifyMe” |
| *point | - e.g., “SLR” or “OCSServer” |
| *inService | - Boolean.TRUE or Boolean.FALSE |
| *binding | - “Java” or “C++” |

Call the accessor methods of OCSMap to obtain these values. To discontinue being notified, call notifyMe( ) with false as the first parameter.

On Demand ‘Point In Service’ Queries

If it is desired to ask the OCS Server if another point is currently in service at a particular point in time call the inService method:

public boolean inService(String point) throws Exception;

This assertion should never fail:

| | |
|---|---|
| point.register(“MyPointName”); | // Register with |

the OCS Server

| | |
|---|---|
| ASSERT( point.inService(“MyPointName”) ); | // Am I in |

service?

Again, if it is desired to ask if the OCSServer is currently running, it is possible to pass “OCSServer” as the point name.

Server Manipulation

It is possible to kill the server using the IServer interface:

IServer server =

(IPoint)MessagingFactory.createInstance (“IServer”);

server.register(“my name”);
server.killServer( );
server.unregister( );

Documentation

The OCSMap name-value pair collection may contain some of these internal values that begin with an asterisk (*):

| | |
|---|---|
| *type | - String: Why onMap( ) is called: “p2p”, |

“pub/sub”, “notification”, or “system”

| | |
|---|---|
| *topic | - String: if *type=“pub/Sub” then *topic |

is the topic of the message

| | |
|---|---|
| *from | - String: The sender of the message |
| *to | - String: The recipient of the message |
| *synchronous | - Boolean: If message is synchronous: |

Boolean.TRUE or Boolean.FALSE.

| | |
|---|---|
| *seq | - Long: Sequence number (internal unique |

tracking number for synchronous Point-to-Point)

| | |
|---|---|
| *origSeq | - Long: Sequence number for routing synchronous |

response message back to original sender

| | |
|---|---|
| *errorMessage | - String: Possible error message |
| *event | - String: if *type=notification then |

*event describes the event type like “notifyMe”

| | |
|---|---|
| *point | - String: if *type=notification and |

*event=NotifyMe then *point is the point coming in service or out of
service

| | |
|---|---|
| *inService | - Boolean: if *type=notification and |

*event=NotifyMe then *inService tells if going in service or out of
service

| | |
|---|---|
| *binding | - String: The language binding of the sender: |

“Java” or “C++”

OCS Internal Commands:

| | |
|---|---|
| - clientStart | - The first message a client sends to the |

server to register.

| | |
|---|---|
| - clientStartResponse | - Confirmation that the client is |

registered.

| | |
|---|---|
| - map | - Point-to-Point OCSMap message. |
| - mapTopic | - Pub/Sub OCSMap message. |
| - broadcast | - Broadcast message sent to all clients. |
| - subscribe | - Request to subscribe to a Pub/Sub topic. |
| - notifyme | - Request to be notified when a point goes in |

and out of service

| | |
|---|---|
| - killServer | - Request to server to exit. |

| | | |
|---|---|---|
| public class MessagingConstants { | | |
| public final static int MESSAGE_SUCCESS | = 10; | - |
| Asynchronous success | | |
| public final static int MESSAGE_TIMEOUT | = 20; | - |
| Synchronous timeout | | |
| public final static int MESSAGE_MAP | = 34; | - |
| Synchronous success | | |
| public final static int MESSAGE_ERROR | = 40; | - Internal |
| error | | |
| public final static String ICS_PASSWORD | = “45gh” | - |
| Registration Password for ICS users | | |
| } | | |

Extensions to the Present Embodiment:

- Increase maximum message length.
- Add more datatypes.
- Obtain a collection values stored in OCSMap.
- Persist data if recipient if currently offline.
- OCSServer up/down notifications.
- Use log4j.
- Skip networking if destination is in same application/JDK.
- Peer to Peer direct with connection optimization (not all

possibilities open)

- Security Model (Registration password).
- Encryption.
- RMI-like stub tool.
- Plug in conversions.
- Compression.

Having now described the present system and its architecture, a further description—given by system Use Case Diagrams in UML—will now be discussed.

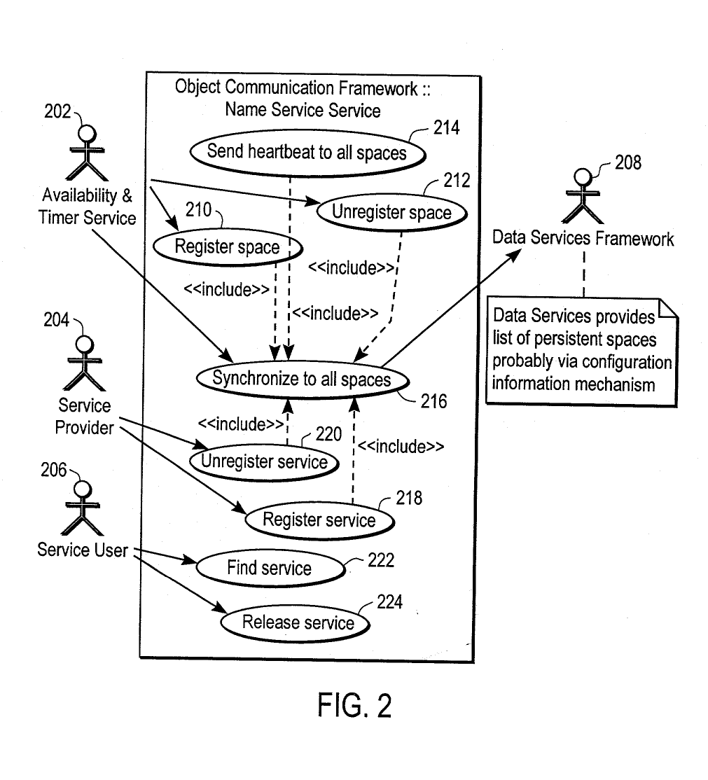

FIG. 2 is a use case diagram of a name service used by the present invention. The name service component maintains a synchronized list of services across multiple run-time spaces. In the following description, it will be appreciated that the numbers in FIG. 2 are used as headings below for typical description fashion for use cases in UML.

Name Service Use Case Diagram

System Use Case: Register Space (210):

Notify all spaces that this space is now in service. An internal message is sent to all other run-time spaces notifying them that this space is on line.

System Actors

Primary: Availability & Timer Service 202

Pre-Conditions

1. Space unregistered

Flow of Events

Scenario: Basic Flow

1. Availability & Timer Service recognizes that this space has “come on line” and fires “on start” type of event.

2. Register space is called.

3. Data services is queried to find list of all spaces.

4. Broadcast message is sent to all spaces notifying them that this space is now online.

Post-Conditions

This space is now on line. Services residing in this space can now register themselves so that other services can use them.

System Use Case: Unregister space (212):

This notifies all spaces that this space is no longer in service. Additionally, this sends an internal message to other spaces.

System Actors

Primary: Availability & Timer Service 202

Secondary: Data Services Framework. 208

Pre-Conditions

1. Registered space.

Flow of Events

Scenario: Basic Flow

1. Availability & Timer Service recognizes that this space is “going offline” and fires “on stop” type of event.

2. Unregister space is called.

3. Data services is queried to find list of all spaces.

4. Broadcast message is sent to all spaces notifying them that this space is now offline.

Post-Conditions

Services residing in this space are automatically unregistered.

System Use Case: Send heartbeat to all spaces (214):

This sends a communication message to all spaces reminding them that this space is operating correctly. Some type of watchdog behavior might be desirable to detect if a space goes out of service ungracefully.

System Actors

Primary: Availability & Timer Service 202

Secondary: Communications Service

Secondary: Data Services Framework 208

Flow of Events

Scenario: Basic Flow

1. Availability & Timer Service timer fires an event at periodic intervals.

2. Heartbeat message is sent to all other spaces.

3. Acknowledgements are received from all spaces within a standard maximum timeframe.

Scenario: Acknowledgement not received

1. Acknowledgment is not received within a maximum timeframe.

2. All services within the failed space are ‘marked’ as being unavailable.

Post-Conditions

All spaces have recent information that this space is available.

System Use Case: Synchronize to all spaces (216):

This synchronizes data from this space to all other spaces. This is the mechanism for broadcasting internal messages from one space to all the others, e.g., that a space is now online, that a service is now online, etc. Individual internal messages are pushed to all the other run-time spaces.

System Actors

Primary: Availability & Timer Service 202

Secondary: Communications Service

Secondary: Data Services Framework 208

Pre-Conditions

1. Space registered.

Post-Conditions

Information has been propagated to all registered spaces.

System Use Case: Register service (218):

This notifies all spaces that this service is available for use.

System Actors

Primary: Service Provider 204

Pre-Conditions

1. Service is unregistered.

Post-Conditions

Other system services are now free to use the features of this service.

System Use Case: Unregister Service (220)

This notifies all spaces that this service is no longer available to use.

System Actors

Primary: Service provider

Pre-Conditions

1. Service is registered.

Post-Conditions

The service is unavailable; other system services are no longer free to use the features of this service.

System Use Case: Find Service (222):

This finds a given service so that its features can be used. The given service can be in the current space or some other space.

System Actors

Primary: Service user 206

Pre-Conditions

1. The service should be running in a space that is currently in service. Otherwise, see alternate scenarios.

Flow of Events

Scenario: Basic Flow

1. The given service is running and can therefore be used.

Scenario: Service not found

1. The given service was not found in the synchronized list of available services.

Scenario: Service out of service

1. The given service is not running because the space where the service resides is not in service.

Post-Conditions

1. Features of the found service can now be exercised.

2. The found service is prohibited from going out of service until all references are released.

System Use Case: Release service

This declares that the given service will no longer be used.

System Actors

Primary: Service user

Pre-Conditions

1. Service found.

Post-conditions

1. Features of the service can no longer be exercised.

2. If all references are released, the service is allowed to go out of service.

Event Use Case Diagram

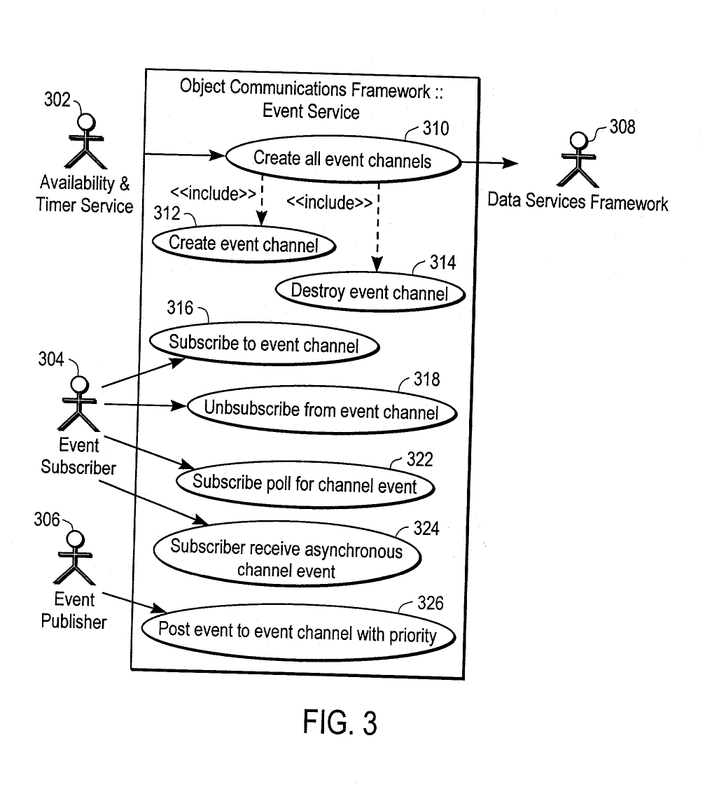

FIG. 3 shows the Event Use-Case diagram. The event component implements a communications mechanism between services. One possible mechanism is the asynchronous “publish-and-subscriber” (commonly called pub/sub) communications model so that objects can “fire and forget” a message to another service or collection of services via a well-known event channel name. The service does not support the point-to-point model.

System Use Case: Create All Event Channels (310)

This creates an event channel so that it can be used to communicate between services. It is called when the system is started.

System Actors

Primary: Availability & Timer Service 302

Secondary: Data Services Framework 308

Flow of Events

Scenario: Basic Flow

1. System is started causing the availability event to be fired to run any system initialization routines.

2. Query the Data Services framework to obtain a list of all event channels.

3. Call Create Event Channel for each.

Post-Conditions

Event channels are now ready for use.

System Use Case: Create event channel (312):

This creates an event channel so that it can be used to communicate between services.

System Actors

Secondary: Data Services Framework 308

Pre-Conditions

1. Event channel does not already exist.

Flow of Events

Scenario: Basic Flow

1. Create event channel

2. Create channel calls the Communications Service to notify all run-time spaces that the channel exists.

Post-Conditions

Event channel is now ready to publish or subscribe to.

System Use Case: Destroy Event Channel (314):

This destroys an event channel so that it can be used to communicate between services.

System Actors

Secondary: Data Services Framework 308

Pre-Conditions

1. Event channel already exists.

Flow of Events

Scenario: Basic Flow

1. Create event channel

2. Create channel calls the Communications Service to notify all run-time spaces that the channel no longer exists.

Post-Conditions

Event channel is no longer ready to publish or subscribe to.

System Use Case: Subscribe to event channel (316):

This subscribes to an event channel so that channel events can be received.

System Actors

Primary: Event Subscriber 304

Pre-Conditions

Event channel must exist.

Flow of Events

Scenario: Basic Flow

1. Subscribe to event channel

Post-Conditions

The event subscriber will receive any events published to the event channel.

System Use Case: Unsubscribe From Event Channel (318):

This unsubscribes from an event channel so that the entity will no longer receive channel events.

System Actors

Primary: Event Subscriber 304

Pre-Conditions

Event channel must exist.

Post-Conditions

The event subscriber will no longer receive any events published to the event channel.

System Use Case: Post Event Object to Event Channel with Priority (320):

This posts an event to an event channel so that subscribers can receive it.

System Actors

Primary: Event Publisher 306

Secondary: Communications Service

Pre-Conditions

Event channel must exist.

Post-Conditions

1. Object posted into queue/channel.

System Use Case: Subscriber Poll for Event Channel Event (322):

This polls to see if the event channel contains an event.

System Actors

Primary: Event Subscriber 304

Secondary: Communications Service

Pre-Conditions

Event channel must exist.

Flow of Events

Scenario: Basic Flow

1. If an event has been published to the event channel, the event is returned.

Scenario: Empty Event Channel

1. If Event channel is empty, a special “empty channel” event is returned.

Post-Conditions

1. Event returned

System Use Case: Subscriber Receive Asynchronous Event Channel Event (324):

This causes an event-channel event to be received by a event channel subscriber.

System Actors

Primary: Event Subscriber 304

Secondary: Communications Service

Pre-Conditions

Event channel must exist.

Post-Conditions

1. Event received.

It has now been described a novel method and system for allowing clients to send opaque messages to other clients using several different message delivery types—as herein disclosed—to allow for a robust means of communications. It will be appreciated that the scope of the present invention should not be limited to the recitation of the embodiments disclosed herein. Moreover, the scope of the present invention contemplates all obvious variations and extensions thereof.

1. In a network, said networks supporting a plurality of network objects, and wherein said network objects require communications between said plurality of network objects;
a method for providing communications between network objects, the steps of said method comprising:
registering said objects desiring communications;
accepting a communications message from at least one of said objects, said communication addressing one of said plurality of network objects;
determining the mode of message delivery for said message;
delivering said message according to the mode of message delivery determined.

2. The method as recited in claim 1 wherein said network comprises a plurality of distributed network objects and further wherein the step of registering objects further comprises registering said plurality of distributed network objects in a central service.

3. The method as recited in claim 1 wherein said step of accepting a communication message further comprises handling said communication message in an event-driven programming mode.

4. The method as recited in claim 1 wherein the step of determining the mode of message delivery further comprises selecting a synchronous mode of message delivery.

5. The method as recited in claim 1 wherein the step of determining the mode of message delivery further comprises selecting an asynchronous mode of message delivery.

6. The method as recited in claim 1 wherein the step of determining the mode of message delivery further comprises selecting peer-to-peer mode of message delivery.

7. The method as recited in claim 1 wherein the step of determining the mode of message delivery further comprises selecting store-and forward mode of message delivery.

8. The method as recited in claim 1 wherein the step of determining the mode of message delivery further comprises selecting a broadcast mode of message delivery.

9. The method as recited in claim 1 wherein the step of determining the mode of message delivery further comprises selecting a publication-and-subscriber mode of message delivery.

10. In a network comprising a plurality of users communicating with a plurality of spaces and a plurality of services associated with said spaces available within said network, a method for facilitating communications between users and services within said network, the steps of said method comprising:
registering said spaces, as each said space is available;
broadcasting a message to all spaces when a space becomes available; and
registering said services to its associated space whereby said registered services are available for use by said plurality of services.

11. The method as recited in claim 10 further comprising the steps of:
unregistering said space, as each said space is unavailable; and
broadcasting a message to all spaces when a space becomes unavailable.

12. The method as recited in claim 10 further comprising the steps of:
sending a heartbeat message to said plurality of spaces periodically to ensure operability of said spaces; and
receiving acknowledgement messages from each said space properly operating.

13. The method as recited in claim 10 further comprising the steps of:
sending a find service message from a user requesting a particular service; and
determining whether said particular service is available with in available space.

14. In a network, said network comprising a plurality of services and wherein said plurality of services need to communicate with others of said plurality of services, a method for allowing communications between said plurality of services, the steps of said method comprising:
creating one or more event channels, said event channels enabling communications between said plurality of services;
notifying all spaces that an event channel exists;
subscribing services to said events channel to poll for events within said event channel; and
publishing said events from services to said event channel so that other services may poll said events.

15. The method as recited in claim 14 wherein said event channels enable asynchronous modes of communications.

16. In a network, said networks supporting a plurality of network objects, and wherein said network objects require communications between said plurality of network objects;
a system for providing communications between network objects comprising:
a means for registering said objects desiring communications;
a means for accepting a communications message from at least one of said objects, said communication addressing one of said plurality of network objects;
a means for determining the mode of message delivery for said message;
a means for delivering said message according to the mode of message delivery determined.

17. The system as recited in claim 16 wherein said network comprises a plurality of distributed network objects and further wherein said system further comprises a means for registering said plurality of distributed network objects in a central service.

18. The system as recited in claim 16 wherein said means for accepting a communication message further comprises a means for handling said communication message in an event-driven programming mode.

19. The system as recited in claim 16 wherein said means for determining the mode of message delivery further comprises a means for selecting a synchronous mode of message delivery.

20. The system as recited in claim 16 wherein said means for determining the mode of message delivery further comprises a means for selecting an asynchronous mode of message delivery.

21. The system as recited in claim 16 wherein said means for determining the mode of message delivery further comprises a means for selecting peer-to-peer mode of message delivery.

22. The system as recited in claim 16 wherein said means for determining the mode of message delivery further comprises a means for selecting store-and forward mode of message delivery.

23. The system as recited in claim 16 wherein said means for determining the mode of message delivery further comprises a means for selecting a broadcast mode of message delivery.

24. The system as recited in claim 16 wherein said means for determining the mode of message delivery further comprises a means for selecting a publication-and-subscriber mode of message delivery.
